(19) United States
(12) Patent Application Publication
(10) Pub. No.: US 2007/0272758 A1
(43) Pub. Date: Nov. 29, 2007

(54) Cartridge and system for duplicating optical disks

(76) Inventors: Subodh K. Kulkarni, Woodbury, MN (US); Gregory W. Visich, Woodbury, MN (US); Richard W. Molstad, St. Paul, MN (US)

Correspondence Address: Imation Corp., PO Box 64898, St. Paul, MN, 55164-0898, US

(21) Appl. No.: 11/439,838

(22) Filed: May 23, 2006

(51) Int. Cl. G06K 7/00; G06F 17/00

(52) U.S. Cl. 235/486; 235/375

(57) ABSTRACT

The disclosure is directed to a system for ensuring quality duplication using recognized optical disks. A media cartridge is described that confines a plurality of optical disk and utilizes a mechanical lockout mechanism to release the optical disk while preventing a user from inserting unauthorized optical disk into the media cartridge. The mechanical lockout mechanism may use a securing arm and rack, a securing member and locking member, or a plurality of biased fingers to lockout the optical disk. In addition, a cartridge identification tag (CID) may be used to recognize the media cartridge, and a medium identification tag (MID) may be used to recognize the optical disk. By preventing unauthorized optical disk from being used for duplication, the system may ensure that any duplicated optical disk is consistent in quality.

### TECHNICAL FIELD

The invention relates to data storage media and, more particularly, optical data storage media.

### BACKGROUND

Optical data storage disks, or optical disks, have gained widespread acceptance for the storage, distribution and retrieval of large volumes of information. Optical data storage disks include, for example, audio CD (compact disc), CD-R (CD-recordable), CD-RW (CD-rewritable) CD-ROM (CD-read only memory), DVD (digital versatile disk or digital video disk), DVD-RAM (DVD-random access memory), and various other types of writable or rewriteable media, such as magneto-optical (MO) disks, phase change optical disks, and others. Some newer formats for optical data storage disks are progressing toward smaller disk sizes and increased data storage density, such as HD-DVD (high definition-DVD) and Blu Ray formats.

Optical disks stores data in one or more layers of the optical disks. The data may be transferred to the optical disks via a laser that selectively heats portions of the completed optical disks. This process is called duplication because the data from an original optical disk or another type of memory is duplicated in the new optical disks. Duplication may be performed on an individual optical disk or in large quantities of optical disks.

### SUMMARY

In general, the invention is directed to a system for ensuring quality duplication using recognized optical disks, or optical media. A media cartridge is described that confines a plurality of optical disk and utilizes a mechanical lockout mechanism to release the optical disk while preventing a user from inserting unauthorized optical disk into the media cartridge. The mechanical lockout mechanism may use a securing arm and ratcheted rack, a securing member and locking member, or a plurality of biased fingers to lockout the optical disk. Each of the described mechanical lockout mechanisms essentially provides a cartridge that only allows an exit for optical disks.

In addition to the mechanical lockout mechanism, a cartridge identification tag (CID) may be used to recognize the media cartridge to be used with the duplication system. In other embodiments, the system may combine the CID recognition with a medium identification tag (MID) to recognize each optical disk of the cartridge before enabling duplication. By preventing unauthorized optical disk from being used for duplication, the system may ensure that any duplicated optical disk is consistent in quality. For example, some optical disks may stick together in the cartridge and cause malfunctions of the cartridge during manufacturing.

In one embodiment, the invention provides a media cartridge that includes a cartridge housing configured to house a plurality of optical disks, wherein the cartridge housing forms an opening that allows removal of the optical disks. The media cartridge also includes a mechanical lockout mechanism attached to the cartridge housing that prevents re-insertion of an optical disk into the cartridge housing by a user.

In another embodiment, the invention provides a system that includes a media cartridge that houses a plurality of optical disks, wherein the cartridge comprises a cartridge identification tag (CID) that identifies the cartridge. The system also includes a reader that interrogates the CID and a processor that enables access to the plurality of optical disks when the CID is recognized.

In another embodiment, the invention provides a system that includes a plurality of optical disks each comprising a medium identification tag (MID) that identifies each of the plurality of optical disks. The system includes a media cartridge that has a cartridge housing that houses the plurality of optical disks, wherein the cartridge housing forms an opening that allows removal of the optical disks from the cartridge housing, a mechanical lockout mechanism attached to the cartridge housing that prevents re-insertion of the optical disks into the cartridge housing, and a cartridge identification tag (CID) that identifies the cartridge. The system also includes a first reader that interrogates the MID, a second reader that interrogates the CID, and a processor that enables access to the media cartridge and the plurality of optical disks when the MID and CID are recognized.

The invention may provide one or more advantages. For example, the mechanical lockout mechanism prevents a user from inserting optical disks into the cartridge that might reduce duplicated optical disk quality. This may act as a quality control measure by reducing malfunctions and errors during the duplication process. The system may also be capable of identifying a cartridge for use with the duplication system. In addition, the system may employ a reader that identifies each optical disk to ensure that only certain optical disks are used in the duplication process to control the quality of the disk duplication.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a perspective view of an example media cartridge and duplication system that identifies the media cartridge before use.

FIG. 2 is a perspective view of an example media cartridge, optical disk, and duplication system that identifies the cartridge and medium before use.

FIG. 3 is a top view of an example mechanical lockout mechanism of a media cartridge that includes a securing arm to prevent an optical disk from entering the cartridge.

FIG. 4 is a cross-sectional side view of the mechanical lockout mechanism of FIG. 3.

FIG. 5 is a top view of an example mechanical lockout mechanism of a media cartridge that includes a radial securing arm to prevent an optical disk from entering the cartridge.

FIG. 6 is a cross-sectional side view of the mechanical lockout mechanism of FIG. 5.

FIG. 7 is a cross-sectional side view of a mechanical lockout mechanism of a media cartridge that includes a securing member that locks with a locking member that prevents an optical disk from entering the cartridge.

FIG. 8 is a top view of an example mechanical lockout mechanism of a media cartridge that includes a plurality of biased fingers that prevent an optical disk from entering the cartridge.

FIG. 9 is a cross-sectional side view of the mechanical lockout mechanism of FIG. 8.

FIG. 10 is a functional block diagram of a duplication system that identifies a media cartridge before duplication.

FIG. 11 is a flow diagram illustrating an exemplary method to identify the media cartridge in the system.

FIG. 12 is a flow diagram illustrating an exemplary method to identify a media cartridge and an optical disk in the system.

### DETAILED DESCRIPTION

Optical disk duplication systems utilize optical disks that satisfy certain quality control standards with the duplication system in order to maintain the quality of the duplicated optical disk. Without assuring that the quality of the optical disk is at or above a certain standard, the duplicated optical disk may include corrupted data or cause a mechanical dysfunction in a media cartridge. For this reason, according to this disclosure, the media cartridge may include a mechanical lockout mechanism that allows optical disks to exit the cartridge while preventing any optical disk to enter the cartridge. The mechanical lockout mechanism thereby prevents low quality optical disks from being used in the media cartridge of the duplication system.

The duplication system may also employ a reader that interrogates a cartridge identification tag (CID) to recognize the media cartridge as authorized to be used with the duplication system. The duplication system may also employ a reader that interrogates a media identification tag (MID) of the optical disk before duplication to ensure that the optical disk is authorized for use with the duplication system. If either the CID or MID does not match the recognized identities, or the CID and MID do not match each other, the duplication system may eject the optical disk, the media cartridge, or both.

The duplication system may produce duplicated optical disks of consistent quality for the user. Certain optical disks may be constructed and designed for the specific purpose of use by the duplication system. These optical disks may be recognized as produced by a certain manufacturer to control quality of the optical disks. Since these optical disks may be of higher quality and designed specifically for use with the media cartridge and the duplication system, performance of the system may be retained and errors may be limited when compared to lower quality optical disks used by the duplication system. For example, the data layers of the high quality optical disks may be suited for a laser of the duplication system. In addition, the dimensions of the high quality optical disks may be within dimensional tolerances, and the high quality optical disk may not adhere to adjacent optical disks.

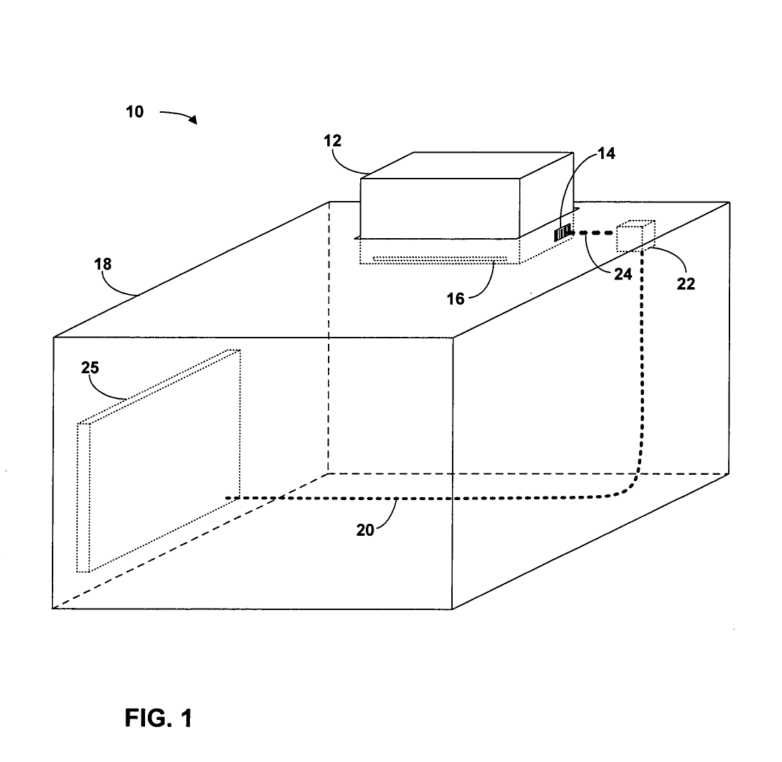

FIG. 1 is a perspective view of an example media cartridge and duplication system that identifies the media cartridge before use. As shown in FIG. 1, system 10 includes media cartridge 12, CID reader 22, and duplicator 18. Cartridge 12 includes cartridge identification tag (CID) 14 and opening 16 that allows optical disks to exit the cartridge. Duplicator 18 accepts cartridge 12 and includes motherboard 25 that is electrically connected to CID reader 22 via cable 20. Motherboard 25 may house a processor that controls CID reader 22 to emit laser 24 that interrogates CID 14. System 10 allows cartridge 12 to be identified by duplicator 18 to indicate that the cartridge contains high quality optical disks designed for duplication with system 10. Cartridge 12 and CID reader 22 may be at least partially housed within duplicator 18 housing. In other embodiments, cartridge 12 and CID reader 22 may be separate from duplicator 18. System 10 may also include other components not shown in FIG. 1. For example, system 10 may also include a duplication laser, optical disk delivery arm, a user interface, an optical disk ejections opening, and other components needed to duplicate optical disks.

Media cartridge 12 includes opening 16 that allows an optical disk to be removed from the cartridge, e.g., pushed out of the cartridge by a duplicator. Generally, one optical disk may exit cartridge 12 via opening 16 at one time. Cartridge 12 may be of any shape or size that is capable of confining, or containing, optical disks used by system 10 for duplication. For example, cartridge 12 may be cuboidal, cylindrical, pyramidal, or another three-dimensional polygon. In some embodiments, cartridge 12 may contain irregular protrusions or indentations that allow for the mechanical lockout mechanism or other component of the cartridge. In alternative embodiments, opening 16 may be located on the top or bottom of cartridge 12 instead of the side as shown in FIG. 1. In other embodiments, opening 16 may include a door that opens when an optical disk exits cartridge 12. In alternative embodiments, media cartridge 12 may also include a mechanical lockout mechanism, described later in this disclosure.

Cartridge 12 may be formed of materials that promote the function of the cartridge as described herein. For example, cartridge 12 may have a housing constructed of a polymer or metal alloy. Cartridge 12 may be reusable or disposable, as determined by the manufacturer. In some embodiments, cartridge 12 is disposable such that new optical disks cannot be placed into the cartridge. In other embodiments, cartridge 12 is reusable by sending the cartridge back to the manufacturer.

CID 14 is attached to cartridge 12 in a position that CID reader 22 can interrogate the CID. CID 14 may be any of a bar code adhered to a cartridge housing, detents formed of the cartridge housing, indents formed in the cartridge housing, or a radio frequency identification (RFID) tag adhered to any surface of cartridge 12. Other forms of CID 14 may include notches, protrusions, grooves, lands, hollows, or other structural features that provide identification of the cartridge. In the case of a bar code or surface variation, CID 14 may be interrogated with laser 24 emitted by CID reader 22. Laser 24 bounces back from CID 14 and the return signal is interpreted by CID reader 22. A processor within duplicator 18 uses the return signal to determine if cartridge 12 is recognized by the duplicator. CID 14 may be indicative of a manufacturer of cartridge 12. In the case of some structural features, CID reader 22 may employ a device that touches the physical structures. If CID 14 is an RFID tag, CID reader may be a RFID reader that energizes the RFID tag and detects the identification of cartridge 12. In any case, duplicator 18 may enable cartridge 12 to be used to distribute optical disks for duplication by the duplicator. If cartridge 12 is not recognized, duplicator 18 may eject the cartridge or deliver an error message to a user to remove the cartridge from system 10.

System 10 may also include a delivery arm (not shown) that moves the optical disk from cartridge 12 to a location within duplicator 18 to duplicate the data onto the optical disk. This location may be within duplicator 18 or at another location of system 10. In some embodiments, system 10 may alter media cartridge 12 once the cartridge is used by the system. In this manner, system 10 may reject any cartridge 12 that has been previously used by the system.

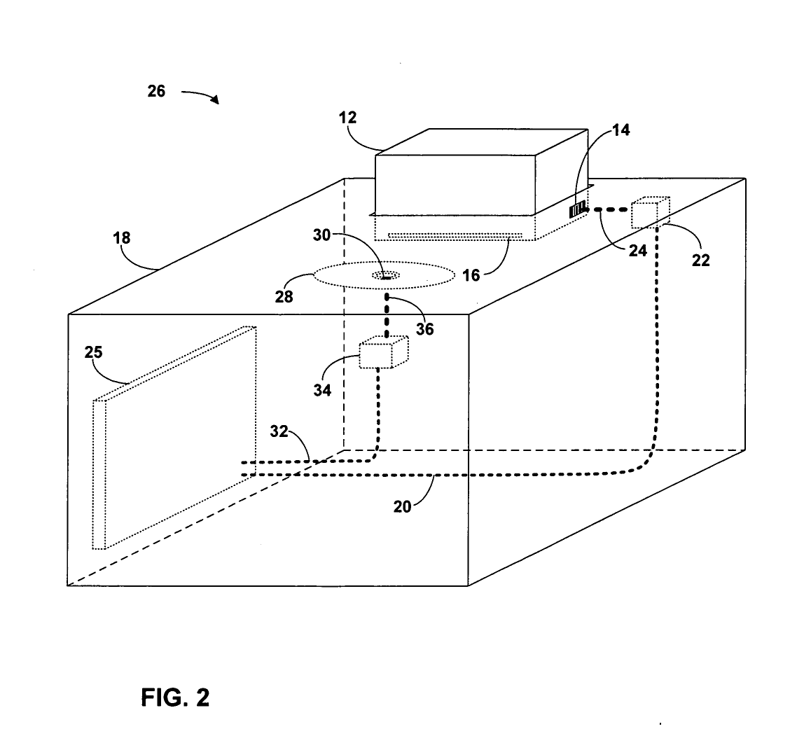

FIG. 2 is a perspective view of an example media cartridge, optical disk, and duplication system that identifies the cartridge and medium before use. As shown in FIG. 2, system 26 includes media cartridge 12, CID reader 22, and duplicator 18, similar to system 10 of FIG. 1. In addition, system 26 includes optical disk 28 and MID reader 34. Optical disk 28 includes medium identification tag (MID) 30 that identifies the optical disk. Duplicator 18 accepts cartridge 12 and includes motherboard 25 that is electrically connected to MID reader 34 via cable 32. Motherboard 25 may include a processor that controls MID reader 34 to interrogate MID 30 via laser 36 before optical disk 28 is duplicated in system 26. In this manner, system 26 ensures that optical disk 28 is of high quality to successfully duplicate the optical disk. The components of system 26 may be at least partially housed within the housing of duplicator 18. In other embodiments, cartridge 12, CID reader 22, and MID reader 34 may be separate from duplicator 18. System 26 may also include other components not shown in FIG. 2. For example, system 26 may also include a duplication laser, optical disk delivery arm, a user interface, an optical disk ejections opening, and other components needed to duplicate optical disk 28.

Duplicator 18 recognizes CID 14 and MID 30 before enabling the duplication process of optical disk 28. As mentioned above with respect to FIG. 1, media cartridge 12 includes opening 16 that allows an optical disk to be removed from the cartridge or pushed out of the cartridge. CID 14 is attached to cartridge 12 in a position that CID reader 22 can access and interrogate the CID. In the case of a bar code or surface variation, CID 14 may be interrogated with laser 24 emitted by CID reader 22. Laser 24 bounces back from CID 14 and the return signal is interpreted by CID reader 22. A processor within duplicator 18 uses the return signal to determine if cartridge 12 is recognized by the duplicator. If cartridge 12 is not recognized, duplicator 18 may eject the cartridge or deliver an error message to a user to remove the cartridge from system 10. If duplicator 18 recognizes CID 14, the duplicator may next interrogate MID 30 of optical disk 28 before duplication may begin. In alternative embodiments, media cartridge 12 may also include a mechanical lockout mechanism, described later in this disclosure.

As used herein, the term blue disk media refers to optical disk media having a data storage capacity of greater than 15 gigabyte (GB) per data storage layer of the disk. Examples of blue disk media include Blu-Ray and HD-DVD, but other future generations of optical disks may also comprise blue disk media. Conventional CDs and DVDs having storage capacity less than 5 GB and magneto-optical (MO) disks having storage capacity of approximately 9 GB are not blue disk media, as used herein. Optical disk 28 may be a compact disk (CD), a digital versatile click (DVD), blue disk media, or any other optical disk utilizing media cartridge 12 to distribute the optical disk to a duplication system. Optical disk 28 may be constructed with multiple layers that include a substrate layer, a data layer, and a cover layer. The data layer consists of bumps are areas that reflect light differently to represent data stored after duplicator 18 duplicates optical disk 28.

In some embodiments, optical disk 28 includes a top layer, or label, which is constructed of a laminate material that is inkjet receptive. In one embodiment, the laminate is formed as a coating on the substrate (e.g., continuous coating, drying, and curing of one or more solutions and/or dispersions). With this approach, the laminate can comprise known inkjet receptive materials, such as inorganic particles (e.g., silica, alumina, etc.) and a binder, such as polyvinyl alcohol, polyvinyl pyrrolidinone, polyvinyl acetate, polyethyl oxazoline, and gelatin to name but a few. The laminate surface can also contain organic beads or polymeric micro-porous structures without inorganic filler particles. In some embodiments, the laminate may consist of two or more layers.

The laminate top surface of optical disk may include a filler material such as titanium dioxide, barium sulfate, calcium carbonate, aluminum oxide, and/or silicon dioxide to name but a few. While the laminate may be inkjet receptive, the laminate may also prevent any adhesion to the substrate, or bottom, of an optical disk stacked on top of the laminate surface. In this manner, optical disk 28 is free to be removed from a stack of optical disks within media cartridge 12. This may reduce any potential malfunctions from disk sticking when optical disk 28 attempts to exit opening 16.

MID 30 may be a code imprinted at an inner radius of optical disk. MID 30 may be a bar code, structural bumps, an image, or any other element that identifies optical disk 28. MID 30 may be a code indicative of a type of optical disks, a manufacturer of optical disk 28, a user identification, or a compatibility code for duplicator 18. MID reader 34 may emit a laser 36 that interrogates MID 30 from a variety of angles with respect to optical disk 28.

Once duplicator 18 communicates with MID reader 34 via cable 32 to interrogate MID 30, the duplicator may determine if optical disk 28 is recognized for use with system 26. The recognition of MID 30 may be one of a variety of criteria. In one embodiment, CID 14 and MID 30 may indicate that media cartridge 12 and optical disk 28, respectively, have the same manufacturer. In other embodiments, CID 14 and MID 30 may be recognized as associated, or compatible, with each other. In alternative embodiments, CID 14 and MID 30 may simply indicate that both media cartridge 12 and optical disk 28 are associated with duplicator 18. In any case, if one or both of CID 14 and MID 30 do not fit the recognition criteria of duplicator 18, one or both of cartridge 12 and optical disk 28 may be ejected from system 26. Alternatively, a user may receive an error message regarding the failed recognition and be required to manually remove at least one of cartridge 12 and optical disk 28.

MID 30 may be read while optical disk 28 is within cartridge 12 or after the optical disk has been removed from the cartridge. In some embodiments, CID 14 and MID 30 may be interrogated by the same reader. Instead of CID reader 22 and MID 34 interrogating CID 14 and MID 30 separately, CID reader 22 may also interrogate MID 30 of optical disk 28. Utilizing one reader in system 26 may reduce the size and complexity of the system while recognizing each CID and MID.

System 26 may also include a delivery arm (not shown) that moves the optical disk from cartridge 12 to a location within duplicator 18, so that the duplicator may duplicate the data onto the optical disk. This location may be within duplicator 18 or at another location of system 10. In some embodiments, system 26 may alter media cartridge 12 once the cartridge is used by the system. In this manner, system 10 may reject any cartridge 12 that has been previously used by the system.

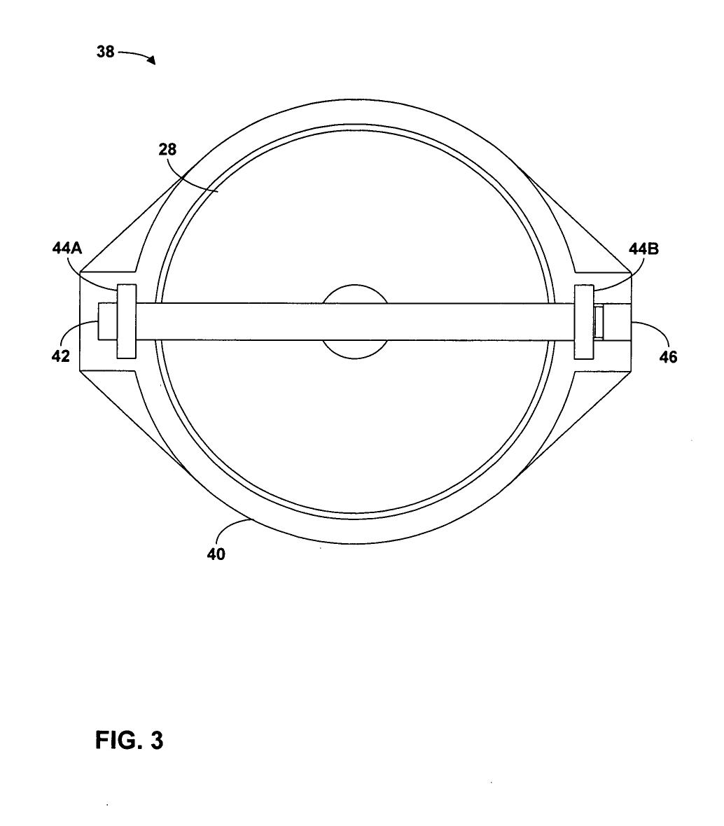

FIG. 3 is a top view of an example mechanical lockout mechanism of a media cartridge that includes a securing arm to prevent an optical disk from entering the cartridge. As shown in FIG. 3, media cartridge 38 is an embodiment of media cartridge 12 shown in FIGS. 1-2. Media cartridge 38 includes a mechanical lockout mechanism that includes slots 44A and 44B, securing arm 42 and rack 46. The components of the mechanical lockout mechanism are attached to cartridge housing 40, which confines optical disk 28. Optical disk 28 exits out of a side at the bottom of cartridge housing 40. The top of cartridge 38 is removed for clarity.

Cartridge housing 40 is cylindrical to accept a plurality of optical disk 28, but the housing may be constructed in a variety of other shapes. Slots 44A and 44B allow securing arm 42 to slide down with gravity as optical disks are removed from cartridge 38. Both slots 44A and 44B keep securing arm 42 from rotating within cartridge housing 40 or tilting such that the securing arm can be moved away from the opening of the housing. Rack 46 includes multiple teeth oriented such that securing arm 42 can only be moved in one direction with respect to rack 46, e.g. closer to the opening in cartridge housing 40 as optical disks are removed for duplication.

The mechanical lockout mechanism prevents any optical disk 28 from entering or re-entering cartridge housing 40. In this manner a user may be unable to insert low quality or unauthorized optical disks into media cartridge 38 for duplication. Low quality optical disks may cause errors during the duplication process or cause malfunctions as the optical disks are removed from cartridge housing 40.

Generally, cartridge housing 40 has an inner diameter between 80 mm and 130 millimeters. Specifically, the inner diameter of cartridge housing 40 may be 122 mm. Securing arm 42 may have a width between 5 mm and 40 mm, while the length of the securing arm may be at least 10 mm longer than the diameter of housing 40. In alternative embodiments, securing arm 42 may be constructed of a different shape than a rectangle. For example, securing arm 42 may be circular in shape similar to the size of optical disk 28 confined within housing 40. Cartridge housing 40 may include a cover at the top over securing arm 42. In other embodiments, cartridge housing 40 may not have a cover over securing arm 42.

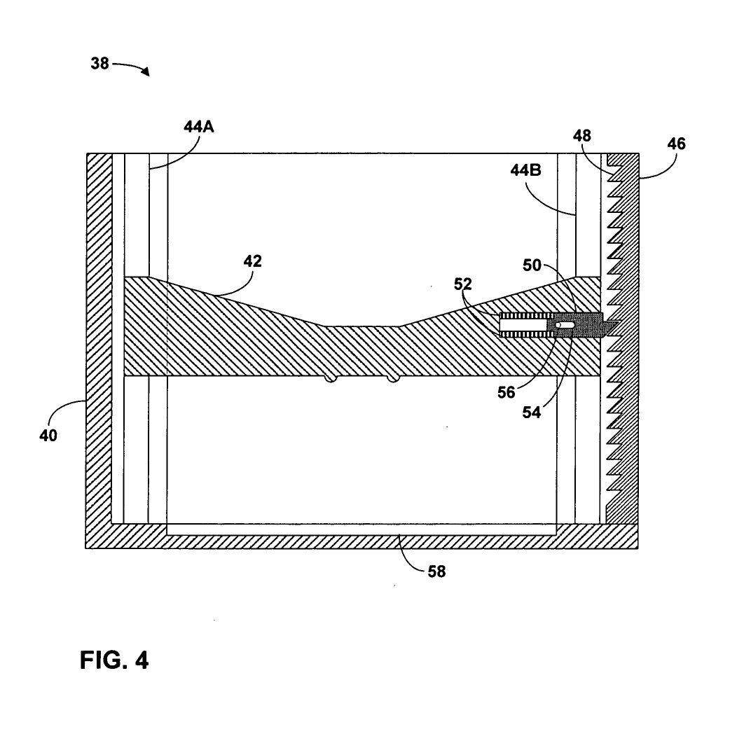

FIG. 4 is a cross-sectional side view of the mechanical lockout mechanism of FIG. 3. As shown in FIG. 4, securing arm 42 is positioned in the middle of cartridge housing 40. Rack 46 includes teeth 48 and housing 40 includes opening 58 that allows optical disk 28 to exit media cartridge 38. Securing arm 42 includes plunger 50, bias members 52, plunger void 54, and plunger stop 56. Optical disks are not shown in FIG. 4; however, securing arm 42 may contact the topmost optical disk of the stack of optical disks confined within cartridge housing 40. The top of cartridge 38 is removed for clarity.

Cartridge housing 40 includes slots 44A and 44B that allow securing arm 42 to move down as optical disks leave the housing for duplication, as shown in FIG. 3. Slots 44A and 44B also keep securing arm 42 square to the inner walls of cartridge housing 40. Rack 46 is formed into the inside of housing 40 with multiple teeth 48 located along the inner surface of the rack. As securing arm 42 moves toward opening 58 as optical disks are removed from cartridge housing 40, plunger 50 moves to the next tooth of teeth 48. The slanted interface between plunger 50 and teeth 58 provides force against bias members 52, e.g., springs, that moves the plunger into securing arm 42 to allow the securing arm to move down. Once plunger 50 moves past the edge of the tooth, bias members 52 push the plunger into the next tooth. In this manner, securing arm 42 is prevented from moving away from opening 58, i.e. up into cartridge housing 40. While opening 58 is displayed as on the side of cartridge housing 40, the opening may be in the bottom of the housing in other embodiments.

Plunger 50 may move to the next tooth of teeth 48 for every optical disk 28 that exits cartridge housing 40. It may be beneficial for the space between each tooth of teeth 48 to be smaller to allow smaller incremental movement of securing arm 42 with respect to cartridge housing 40. In some embodiments, plunger 50 may move past two or more teeth 48 for each optical disk 28 that exits cartridge housing 40. Alternatively, two or more optical disks may need to exit cartridge housing 40 before plunger 50 moves to the next tooth of rack 46.

Plunger stop 56 is attached to securing arm 42 and moves within plunger void 54 to keep plunger 50 from moving too far in any direction. While bias members 52 may be metal springs, the bias members may be any device capable of producing a force that keeps plunger 50 against rack 46. Alternative bias members 52 may be compressible rubbers, deflected metal bars, or active bias devices such as pneumatic or hydraulic devices. In some embodiments, securing arm 42 may move with the assistance of devices other than simply gravity. For example, a spring (not shown) may be attached between securing arm 42 and a top cover (not shown) of cartridge housing 40 to force the securing arm against any remaining optical disks within cartridge 38. In this manner, cartridge 38 may be utilized in an inverted configuration with certain duplication systems.

Cartridge housing 40 may be constructed with a rigid polymer such as polycarbonate, polyurethane, polypropylene, polyethylene, polystyrene, or any other moldable polymer. In some embodiments, cartridge housing 40 may be constructed of a composite material or metal alloy if necessary to the design and function of the housing. Similarly, rack 46 may be constructed of materials identical or compatible with the materials used to construct cartridge housing 40. A polymer, composite, or metal alloy may also be used to construct securing arm 42. However, plunger 50 may be constructed of a rigid and strong material to prevent flexing, deformation, or fracture of the plunger if a user attempts to insert optical disks into cartridge housing 40. If damage would occur to cartridge 38, the cartridge may become non-functional in the duplication system.

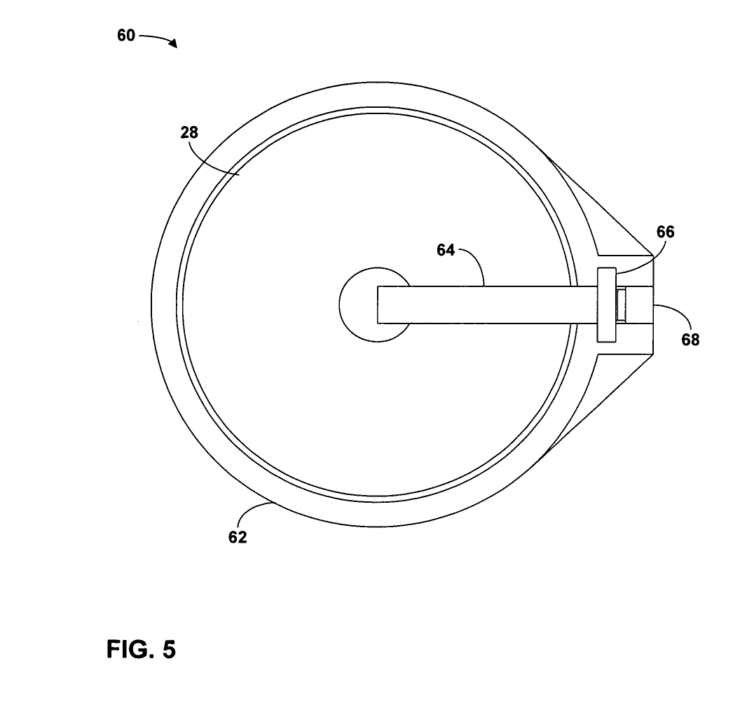

FIG. 5 is a top view of an example mechanical lockout mechanism of a media cartridge that includes a radial securing arm to prevent an optical disk from entering the cartridge. As shown in FIG. 5, media cartridge 60 is an embodiment of media cartridge 12 shown in FIGS. 1-2 and similar to media cartridge 38 of FIGS. 3-4. Media cartridge 60 includes a mechanical lockout mechanism that includes slot 66, securing arm 64 and rack 68. The components of the mechanical lockout mechanism are attached to cartridge housing 62, which confines optical disk 28. Optical disk 28 exits out of a side at the bottom of cartridge housing 62. The top of cartridge 60 is removed for clarity.

Cartridge housing 62 is cylindrical to accept a plurality of optical disk 28, but the housing may be constructed in a variety of other shapes. Slot 66 allows securing arm 64 to slide down with gravity as optical disks are removed from cartridge 60, where the securing arm covers a radius of optical disk 28. Slot 66 keeps securing arm 64 from rotating within cartridge housing 62 or tilting such that the securing arm can be moved away from the opening of the housing. Rack 68 includes multiple teeth oriented such that securing arm 64 can only be moved in one direction with respect to rack 46, e.g., closer to the opening in cartridge housing 62 as optical disks are removed for duplication.

The mechanical lockout mechanism prevents any optical disk 28 from entering or re-entering cartridge housing 62. In this manner, a user may be unable to insert low-quality or unauthorized optical disks into media cartridge 60 for duplication. Low quality optical disks may cause errors during the duplication process or cause malfunctions as the optical disks are removed from cartridge housing 62.

Generally, cartridge housing 62 has an inner diameter between 80 mm and 130 millimeters. Specifically, the inner diameter of cartridge housing 62 may be 122 mm. Securing arm 64 may have a width between 5 mm and 40 mm, while the length of the securing arm may be at least 10 mm longer than the radius from the center of housing 62 to the inner surface of the housing. In alternative embodiments, securing arm 64 may be constructed of a different shape than a rectangle. For example, securing arm 64 may be semi-circular in shape similar to the size of half of optical disk 28 confined within housing 62. Cartridge housing 62 may include a cover at the top over securing arm 64. In other embodiments, cartridge housing 62 may not have a cover over securing arm 64.

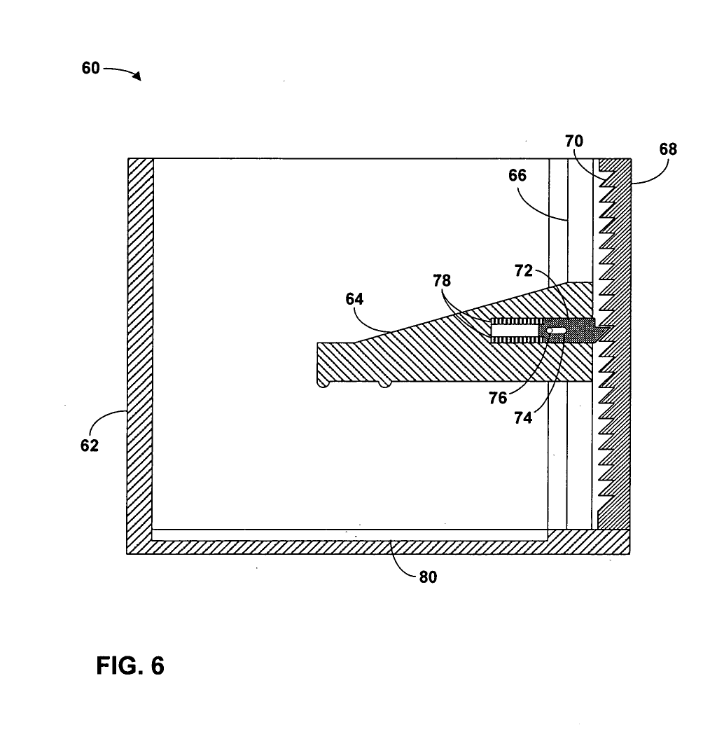

FIG. 6 is a cross-sectional side view of the mechanical lockout mechanism of FIG. 5. As shown in FIG. 6, securing arm 64 is positioned in the middle of cartridge housing 62. Rack 68 includes teeth 70 and housing 62 includes opening 80 that allows optical disk 28 to exit media cartridge 60. Securing arm 64 includes plunger 72, bias members 78, plunger void 74, and plunger stop 76. Optical disks are not shown in FIG. 6; however, securing arm 64 may contact the topmost optical disk of the stack of optical disks confined within cartridge housing 62. The top of cartridge 60 is removed for clarity.

Cartridge housing 62 includes slot 66 that allow securing arm 64 to move down as optical disks leave the housing for duplication, as shown in FIG. 5. Slot 66 also keep securing arm 64 square to the inner wall of cartridge housing 62 without the need for the securing arm to contact another area of the housing. Rack 68 is formed into the inside of housing 62 with multiple teeth 70 located along the inner surface of the rack. As securing arm 64 moves toward opening 80 as optical disks are removed from cartridge housing 62, plunger 72 moves to the next tooth of teeth 70. The slanted interface between plunger 72 and teeth 70 provides force against bias members 78, e.g., springs, that moves the plunger into securing arm 64 to allow the securing arm to move down. Once plunger 72 moves past the edge of the tooth, bias members 78 push the plunger into the next tooth. In this manner, securing arm 64 is prevented from moving away from opening 80, i.e. up into cartridge housing 62. While opening 80 is displayed as on the side of cartridge housing 62, the opening may be in the bottom of the housing in other embodiments.

Plunger 72 may move to the next tooth of teeth 70 for every optical disk 28 that exits cartridge housing 62. It may be beneficial for the space between each tooth of teeth 70 to be smaller to allow smaller incremental movement of securing arm 64 with respect to cartridge housing 62. In some embodiments, plunger 72 may move past two or more teeth 70 for each optical disk 28 that exits cartridge housing 62. Alternatively, two or more optical disks may need to exit cartridge housing 62 before plunger 72 moves to the next tooth of rack 68.

Plunger stop 76 is attached to securing arm 64 and moves within plunger void 74 to keep plunger 72 from moving too far in any direction. While bias members 78 may be metal springs, the bias members may be any device capable of producing a force that keeps plunger 72 against rack 68. Alternative bias members 78 may be compressible rubbers, deflected metal bars, or active bias devices such as pneumatic or hydraulic devices. In some embodiments, securing arm 64 may move with the assistance of devices other than simply gravity. For example, a spring (not shown) may be attached between securing arm 64 and a top cover (not shown) of cartridge housing 62 to force the securing arm against any remaining optical disks within cartridge 60. In this manner, cartridge 60 may be utilized in an inverted configuration with certain duplication systems.

Cartridge housing 62 may be constructed with a rigid polymer such as polycarbonate, polyurethane, polypropylene, polyethylene, polystyrene, or any other moldable polymer. In some embodiments, cartridge housing 62 may be constructed of a composite material or metal alloy if necessary to the design and function of the housing. Similarly, rack 68 may be constructed of materials identical or compatible with the materials used to construct cartridge housing 62. A polymer, composite, or metal alloy may also be used to construct securing arm 64. However, plunger 72 may be constructed of a rigid and strong material to prevent flexing, deformation, or fracture of the plunger if a user attempts to insert optical disks into cartridge housing 62. If damage would occur to cartridge 60, the cartridge may become non-functional in the duplication system.

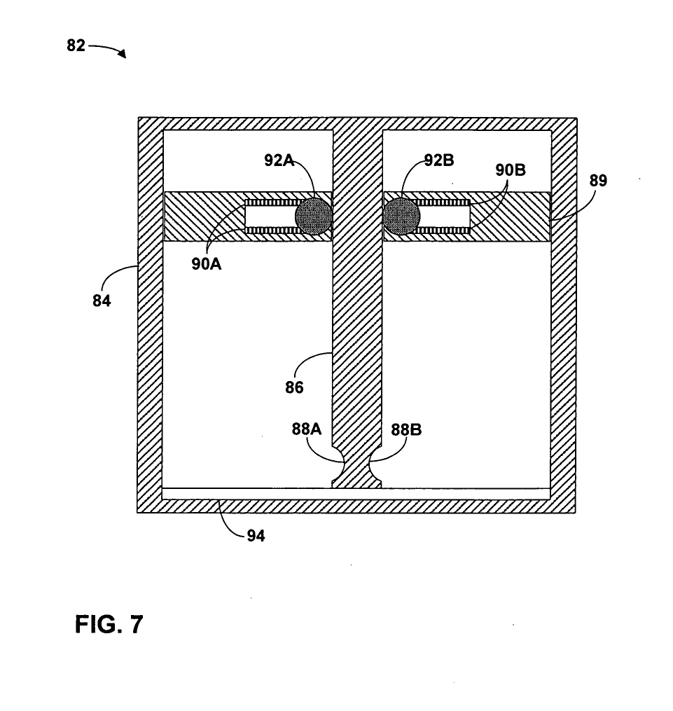

FIG. 7 is a cross-sectional side view of a mechanical lockout mechanism of a media cartridge that includes a securing member that locks with a locking member that prevents an optical disk from entering the cartridge. As shown in FIG. 7, media cartridge 82 is an embodiment of media cartridge 12 shown in FIGS. 1-2. Cartridge housing 84 confines optical disks and includes a mechanical lockout mechanism that utilizes post 86, indents 88A and 88B (collectively indents 88), securing disc 89, bias members 90A and 90B, locking members 92A and 92B, and opening 94. Optical disks are not shown in FIG. 7; however, securing disc 89 may contact the topmost optical disk of the stack of optical disks confined within cartridge housing 84.

Cartridge housing 84 is generally cylindrical in shape to accommodate optical disk 28, where post 86 is disposed within a center hole of the optical disk. Securing disc 89 rests on top of the optical disks within cartridge 82 and lowers within housing 84 with the aid of gravity as optical disk 28 exits the housing though opening 94. When the last optical disk exits housing 84, securing disc 89 drops to a locking position on post 86 and locking members 92A and 92B mate to indents 88A and 88B, respectively. Bias members 90A and 90B provide the force that moves each locking member 92A and 92B into position within indents 88. Once mating has occurred between locking members 92A and 92B and indents 88, securing disc 89 cannot be moved up post 86. This mechanism prevents a user from inserting low quality optical disks into media cartridge 82.

Locking members 92A and 92B are spheres located within a void of securing disc 89. Bias members 90A and 90B are compressed such that locking members 92A and 92B are in constant contact with post 86. However, the contact between locking members 92A and 92B and post 86 does not produce sufficient friction to inhibit securing disc 89 from sliding along the post as optical disks are removed from cartridge 82. There may be more than two locking members 92A and 92B utilized in cartridge 82. In some embodiments, locking members 92A and 92B may be free to rotate along post 86. In other embodiments, indents 88 may form an indentation around the circumference of post 86. In this manner, securing disc 89 may be free to rotate about post 86 and still lock once all optical disks are removed from cartridge 82.

In alternative embodiments, locking members 92A and 92B may be constructed of different shapes than spheres. For example, locking members 92A and 92B may be formed as wedges, pyramids, cubes, cylinders, or any other shape that may be mated to a structure formed in post 86. Locking members 92A and 92B may even be pins that insert completely through a hole in post 86. Other embodiments of cartridge 82 may include locking members 92A and 92B that mate to indents formed in the inner surface of cartridge housing 84 instead of post 86.

While bias members 90A and 90B may be springs, any other component that may provide a force against locking members 92A and 92B may be used. In some embodiments, one or more springs may be attached to the top of cartridge housing 84 to provide a force to securing disc 89 that keeps the securing disc in contact with the optical disks. In other embodiments, securing disc 89 may have a diameter substantially smaller than the inner diameter of cartridge housing 84 or have voids at certain positions along the circumference of the disc.

Cartridge housing 84 may be constructed with a rigid polymer such as polycarbonate, polyurethane, polypropylene, polyethylene, polystyrene, or any other moldable polymer. In some embodiments, cartridge housing 84 may be constructed of a composite material or metal alloy if necessary to the design and function of the housing. Similarly, securing disc 89 and post 86 may be constructed of materials identical or compatible with the materials used to construct cartridge housing 84. However, locking members 92A and 92B may be constructed of a rigid and strong material to prevent flexing, deformation, or fracture of the locking member if a user attempts to insert optical disks into cartridge housing 84. If damage would occur to cartridge 82, the cartridge may become non-functional in the duplication system.

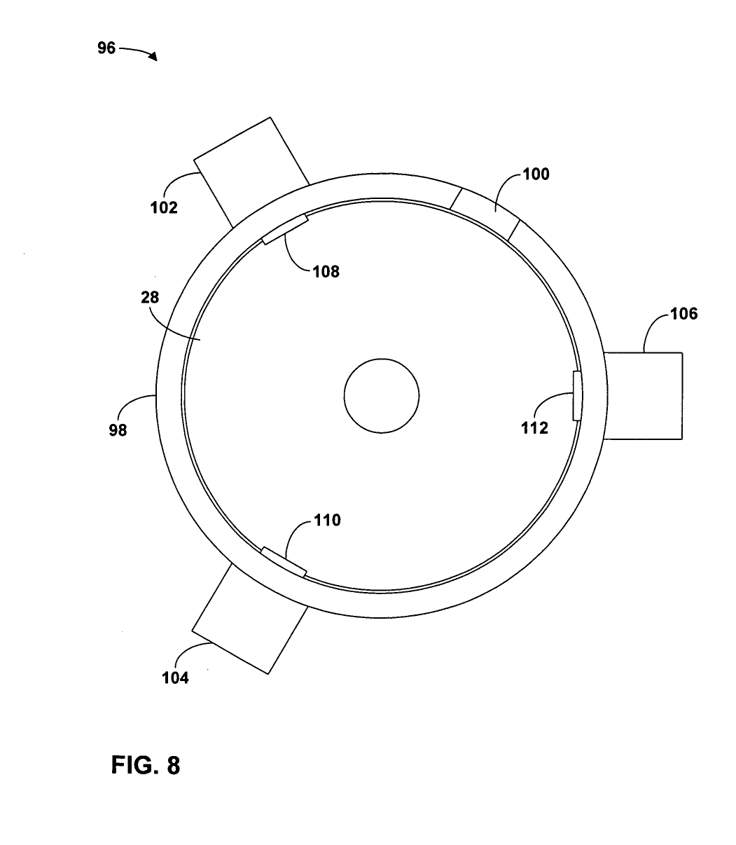

FIG. 8 is a top view of an example mechanical lockout mechanism of a media cartridge that includes a plurality of biased fingers that prevent an optical disk from entering the cartridge. As shown in FIG. 8, media cartridge 96 is an embodiment of media cartridge 12 of FIGS. 1-2. Media cartridge 96 includes a cartridge housing 98 that confines optical disk 28 and mechanical lockout mechanism that includes biased fingers 108, 110 and 112 housed within locking housings 102, 104 and 106. Slot 100 may allow for optical disk 28 to be removed from housing 98. Optical disk 28 may exit media cartridge 96 via rotation of biased fingers 102, 104 and 106, but the biased fingers do not rotate to allow the optical disk or other optical disks to enter housing 98. The top of cartridge 96 is removed for clarity.

Cartridge housing 98 is generally cylindrical in shape to accept optical disk 28. Locking housings 102, 104 and 106 are attached or formed of housing 98 to hold the components of the mechanical locking mechanism. In other embodiments, housing 98 may be formed of other shapes. Biased fingers 108, 110 and 112 protrude out from housing 98. As optical disk 28 exits housing 98, biased fingers 108, 110 and 112 rotate with the optical disk to allow the optical disk to be removed from media cartridge 96. However, biased fingers 108, 110 and 112 cannot rotate in the opposite direction within locking housings 102, 104 and 106, respectively. Therefore, biased fingers 108, 110 and 112 do not allow a user to insert any optical disk into cartridge housing 98.

Biased fingers 108, 110 and 112 may be positioned such that optical disk 28 is free to exit cartridge housing 98 once the optical disk passes the biased fingers. The mechanical lockout mechanism prevents any optical disk 28 from entering or re-entering cartridge housing 98. In this manner, a user may be unable to insert low quality or unauthorized optical disks into media cartridge 96 for duplication. Low quality optical disks may cause errors during the duplication process or cause malfunctions as the optical disks are removed from cartridge housing 98.

Generally, cartridge housing 96 has an inner diameter between 80 mm and 130 mm. Specifically, the inner diameter of cartridge housing 98 may be 122 mm. Biased fingers 108, 110 and 112 may have a width between 10 mm and 25 mm, while the length of the biased fingers protruding beyond housing 98 may be between 1 mm and 10 mm. In alternative embodiments, media cartridge 96 may include less or more biased fingers. For example, media cartridge may only contain two biased fingers or five biased fingers.

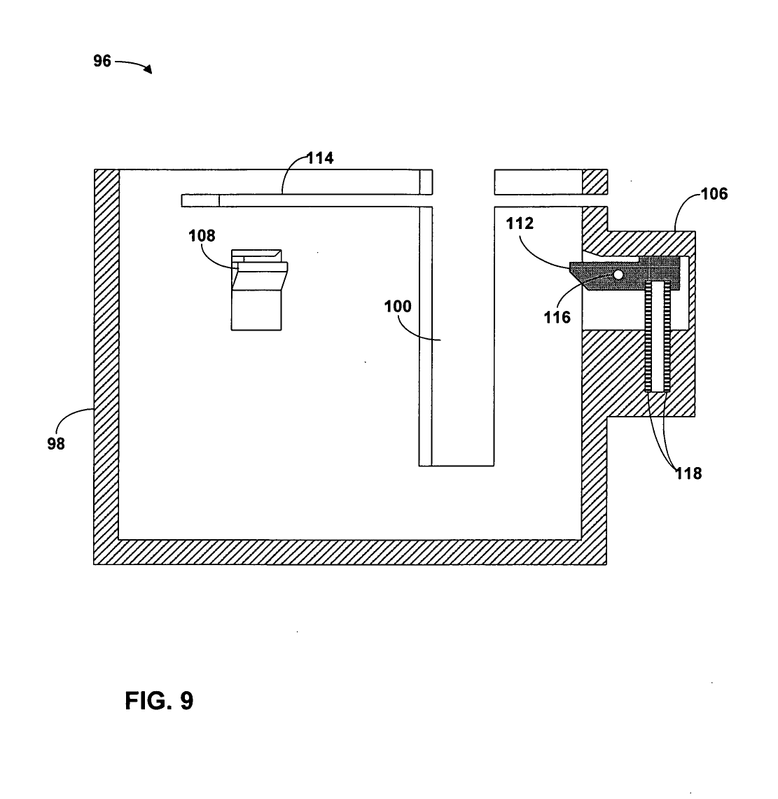

FIG. 9 is a cross-sectional side view of the mechanical lockout mechanism of FIG. 8. As shown in FIG. 9, media cartridge 96 includes cartridge housing 98 that includes slot 100 and supports components of a mechanical lockout mechanism. The mechanical lockout mechanism includes biased fingers 108 and 112, opening 114, pivot 116, bias members 118, and lockout housing 106. Biased finger 108 is shown on an opposing wall of the inside surface of cartridge housing 98. Media cartridge 96 is a top feeding cartridge for system 10 or system 26. The top of cartridge 96 is removed for clarity.

Slot 100 may allow an arm of the duplication system to access optical disk 28 within cartridge housing 98 (not shown in FIG. 9). Optical disk 28 is moved past biased fingers 108, 110 and 112, but biased finger 112 will be described herein as an example. Optical disk contacts the beveled edge of biased finger 112 and causes the biased finger to rotate, or pivot, about pivot 116. At this time, bias members 118 compress to allow that rotation that reduces the protrusion of biased finger 112 beyond cartridge housing 98. Once optical disk 28 has passed biased finger 112, bias members 118 cause the biased finger to snap back into a locked position that prevents any optical disks, specifically low quality optical disks, from entering cartridge housing 98.

Bias members 118 may be springs, an elastic material, or some other component that provides a force to biased finger 112. The force provided by bias members 118 may be determined by the specific optical disk 28 contained within cartridge housing 98 or the number of biased fingers utilized in cartridge 96. In some embodiments, cartridge 96 may include a feeding mechanism that keeps optical disks within housing 98 adjacent to biased fingers 108, 110 and 112. The feeding mechanism may be a disc attached to housing 98 opposite opening 114. The disc may use one or more springs to feed the optical disks towards opening 114.

Cartridge housing 98 may be constructed with a rigid polymer such as polycarbonate, polyurethane, polypropylene, polyethylene, polystyrene, or any other moldable polymer. In some embodiments, cartridge housing 98 may be constructed of a composite material or metal alloy if necessary to the design and function of the housing. Similarly, biased fingers 108, 110 and 112 may be constructed of materials identical or compatible with the materials used to construct cartridge housing 84. However, biased fingers 108, 110 and 112 may be constructed of a rigid and strong material to prevent flexing, deformation, or fracture of the biased fingers if a user attempts to insert optical disks into cartridge housing 98. If damage would occur to cartridge 96, the cartridge may become non-functional in the duplication system.

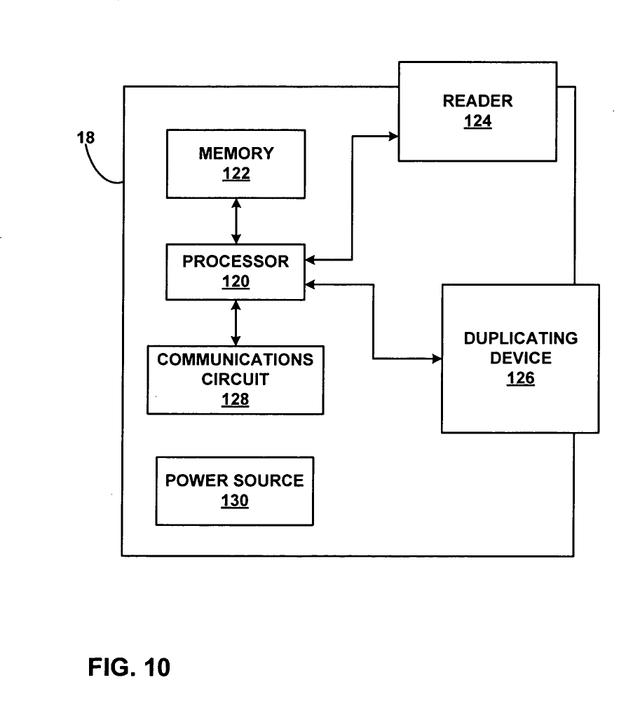

FIG. 10 is a functional block diagram of a duplication system that identifies a media cartridge before duplication. As shown in FIG. 10, duplicator 18 includes processor 120, memory 122, reader 124, duplicating device 126, communications circuit 128, and power source 130. Duplicator 18 may be used within system 10 of FIG. 1 or system 26 of FIG. 2. Duplicator 18 includes electronic components necessary to duplicate data onto an optical disk by using cartridge 12. Duplicator 18 may be housed within a similar housing with cartridge 12, and the duplicator may include other components to perform the functions described herein.

Processor 120 controls reader 124 to read CID 14, MID 30, or both. Reader 124 may include CID reader 22 and MID reader 34, depending on what functions duplicator 18 needs to perform. Processor 120 controls reader 124 according to instructions stored within memory 122 to interrogate CID 14 or CID 14 and MID 30. A signal from the interrogation is returned to processor 120 from reader 124, and the processor processes the signal and compares it to recognized signals in memory 122. If CID 14 is not recognized by duplicator 18, the duplicator may reject the cartridge. In embodiments where reader 124 also interrogates MID 30, duplicator 18 may reject optical disk 28 and cartridge 12 if the MID is not recognized with the data in memory 122. If reader 124 recognizes CID 14 or CID 14 and MID 30 for use with duplicator 18, processor 120 instructs duplicating device 126 to duplicate optical disk 28. As mentioned previously, a recognized CID 14 or MID 30 may indicate that cartridge 12 or optical disk 28 was manufactured by the correct manufacturer.

In some embodiments, an individual CID 14 may be specific to a single use cartridge 12. Processor 120 may store the CID 14 in memory 122 with the first time user, and the processor may later reject cartridge 12 if memory 122 already contains the CID. In this manner, a user may be prevented from removing cartridge 12 and adding low quality optical disks to the cartridge. Alternatively, only CID 14 may be recognized and the mechanical lockout mechanism prevents the user from adding low quality optical disks into cartridge 12.

Processor 120 may also control data flow between memory 122, communications circuit 128, and duplicating device 126. Memory 122 may contain the data for duplicating optical disk 28 with duplicating device 126. Alternatively, communications circuit may receive the data from another device and store a running buffer of data in memory 122 during the duplication process. Processor 120 may also control a user interface (not shown) that allows the user to control duplicator 18. Processor 120 may comprise any one or more of a microprocessor, digital signal processor (DSP), application specific integrated circuit (ASIC), field-programmable gate array (FPGA), or other digital logic circuitry. Memory 122 may include multiple memories for storing a variety of data. For example, one memory may contain instruction protocols, one may contain CID and MID files, and one may contain duplication data for optical disk 28. Memory 122 may include any one or more of a random access memory (RAM), read-only memory (ROM), electronically-erasable programmable ROM (EEPROM), flash memory, or the like.

Communications with duplicator 18 may be accomplished by radio frequency (RF) communication or local area network (LAN) with another computing device or network access point. This communication is possible through the use of communications circuit 128. Communications circuit 128 may be configured to conduct wireless or wired data transactions simultaneously as needed by a user.

Power source 130 delivers operating power to the components of duplicator 18. Power source 130 may utilize electricity from a standard 115 Volt electrical outlet or include a battery and a power generation circuit to produce the operating power. In other embodiments, power source 130 may utilize energy from any outlet that provides between 100 and 240 Volts. In some embodiments, the battery may be rechargeable to allow extended operation. Recharging may be accomplished through the 115 Volt electrical outlet. In other embodiments, traditional batteries may be used.

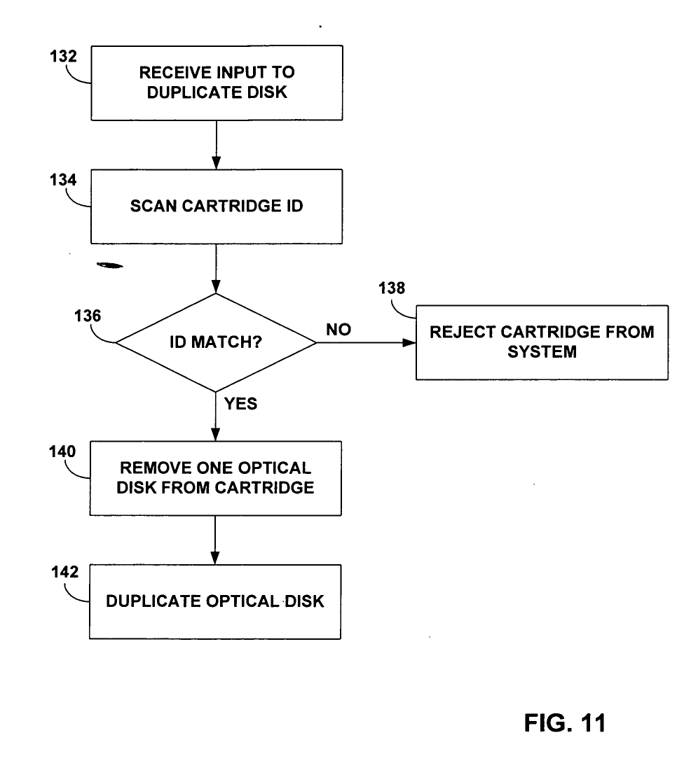

FIG. 11 is a flow diagram illustrating an exemplary method to identify the media cartridge in the system. As shown in FIG. 11, processor 120 (of the block diagram in FIG. 10) receives input from a user to duplicate at least one optical disk 28 from cartridge 12 (132). Processor 120 instructs reader 124 to interrogate CID 14 of cartridge 12 (134). Processor 120 next matches CID 14 to other CIDs stored in memory 122 to attempt to recognize the CID and cartridge 12 (136).

If CID 14 is not recognized, processor 120 interprets the determination as a cartridge 12 that should not be used to deliver optical disks for duplication and rejects the cartridge from system 10 (138). System 10 may automatically eject cartridge 12 or processor 120 may deliver an error message that instructs the user to remove the cartridge. If CID 14 is recognized, processor 120 may initiate the duplication process by removing one optical disk 28 from cartridge 12 (140). Processor 120 may then instruct duplicating device 126 to duplicate data in optical disk 28 (142).

CID 14 may be recognized when the CID is associated with a high quality manufacturer of cartridge 12. System 10 may not need to recognize each optical disk 28, as the mechanical lockout mechanism of cartridge 12 prevents low quality optical disks from being inserted into the cartridge. In some embodiments, the mechanical lockout mechanisms described herein may include an override device that is engaged by processor 120 to remove optical disks or automatically manage any malfunction of the mechanical lockout mechanism.

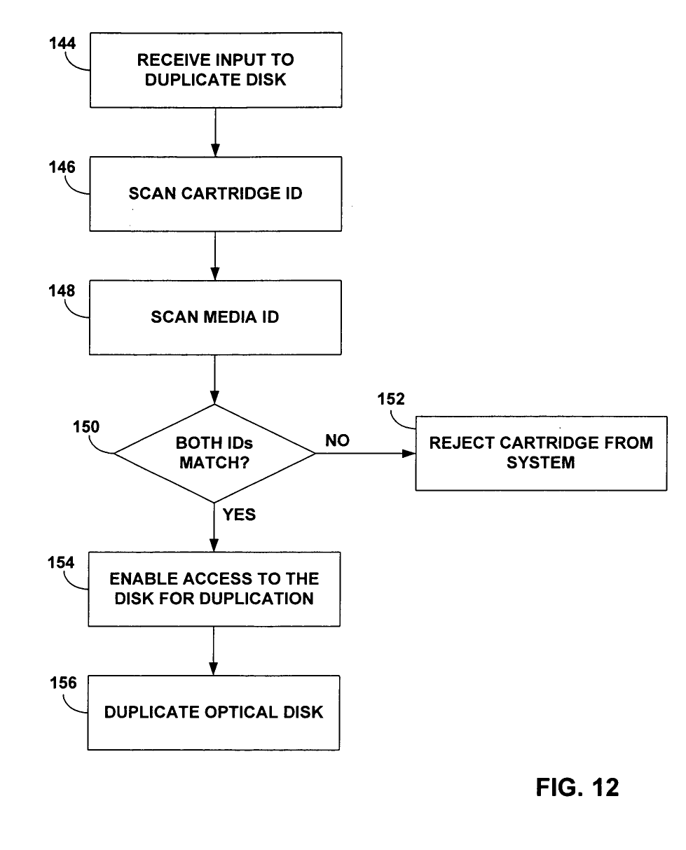

FIG. 12 is a flow diagram illustrating an exemplary method to identify a media cartridge and an optical disk in the system. As shown in FIG. 12, system 26 (shown in the embodiment of FIG. 2) is used for duplicating optical disk 28. Processor 120 receives input from a user to duplicate at least one optical disk 28 from cartridge 12 (144). Processor 120 instructs reader 124 to interrogate CID 14 of cartridge 12 (146). Processor 120 next instructs reader 124 to interrogate MID 30 of optical disk 28 (148). Processor 120 next matches CID 14 to MID 30 to identify if optical disk 28 is associated with cartridge 12 (150). Alternatively, processor 120 individually recognizes each of CID 14 and MID 30 to CIDs and MIDs stored in memory 122.

If CID 14 and MID 30 do not match, or at least one of CID 14 and MID 30 is not recognized, processor 120 interprets the determination as a low quality optical disk 28 and rejects the optical disk from system 10 (152). System 26 may automatically eject optical disk 28 or processor 120 may deliver an error message that instructs the user to remove the optical disk. If CID 14 and MID 30 are recognized, processor 120 may initiate the duplication process by enabling access to optical disk 28 for the duplication process (154). Processor 120 may then instruct duplicating device 126 to duplicate data in optical disk 28 (156).

CID 14 and MID 30 may be recognized when the CID and MID are associated with a high quality manufacturer. System 26 may read MID 30 as a redundant feature that supports the mechanical lockout mechanism of cartridge 12 which prevents low quality optical disks from being inserted into the cartridge. In some embodiments, the mechanical lockout mechanisms described herein may include an override device that is engaged by processor 120 to remove optical disks or automatically manage any malfunction of the mechanical lockout mechanism.

Various embodiments of the invention have been described. For example, a mechanical lockout mechanism of a cartridge may be utilized to prevent low quality optical disks from being used in a duplication process. A duplicator may also read a CID of a media cartridge or an MID of an optical disk to ensure that only high quality optical disks are used for duplication. In this manner, the duplicating system may control the quality of duplicated optical disks.

Nevertheless various modifications can be made to the techniques described herein without departing from the spirit and scope of the invention. For example, although several mechanical lockout mechanisms were described separately, a media cartridge may employ multiple mechanisms to prevent low quality optical disks from being used in the duplication system. In addition, the MID of optical disks may be configured on the optical disks to be read before the optical disks are removed from the media cartridge. These and other embodiments are within the scope of the following claims.

1. A media cartridge, the cartridge comprising:
a cartridge housing configured to house a plurality of optical disks, wherein the cartridge housing forms an opening that allows removal of the optical disks; and
a mechanical lockout mechanism attached to the cartridge housing that prevents re-insertion of an optical disk into the cartridge housing by a user.

2. The cartridge of claim 1, wherein the mechanical lockout mechanism comprises a securing arm that slides along a channel formed within the cartridge housing.

3. The cartridge of claim 2, wherein the securing arm comprises a plunger that mates to one or more teeth of a rack, wherein the one or more teeth of the rack mated to the plunger prevents the securing arm from moving away from the opening of the cartridge housing.

4. The cartridge of claim 3, further comprising a bias member that forces the plunger against the one or more teeth of the rack.

5. The cartridge of claim 1, wherein the mechanical lockout mechanism comprises a securing member that slides along a center post within the cartridge housing, wherein the plurality of optical disks surround the center post.

6. The cartridge of claim 5, wherein the securing member comprises a locking member that mates to an indent formed within the center post, wherein the locking member mates to the indent when one of the plurality of optical disks exits the cartridge housing.

7. The cartridge of claim 6, further comprising a bias member that forces the locking member against the indent.

8. The cartridge of claim 1, wherein the mechanical lockout mechanism comprises a plurality of biased fingers attached to the cartridge housing that pivot via force from one of the plurality of optical disks to allow at least one of the plurality of optical disks to exit the cartridge housing.

9. The cartridge of claim 8, wherein the plurality of biased fingers are equally spaced around a circumference of the cartridge housing.

10. The cartridge of claim 1, further comprising a cartridge identification tag (CID) that identifies the cartridge.

11. The cartridge of claim 1, wherein the plurality of optical disks comprise a top layer that does not adhere to a bottom layer of the plurality of optical disks when the top layer and bottom layer come into contact, wherein the plurality of optical disks are stacked in the media cartridge.

12. A system comprising:
a media cartridge that houses a plurality of optical disks, wherein the cartridge comprises a cartridge identification tag (CID) that identifies the cartridge;
a reader that interrogates the CID; and
a processor that enables access to the plurality of optical disks when the CID is recognized.

13. The system of claim 12, wherein the media cartridge comprises a mechanical lockout mechanism attached to the cartridge housing that allows removal of the optical disks from a cartridge housing of the media cartridge and prevents re-insertion of the optical disks into cartridge housing.

14. The system of claim 12, wherein the CID is at least one of a bar code, a pattern of indents, a pattern of detents, a pattern of indents and detents, an image, and a radio frequency identification (RFID) device.

15. The system of claim 12, further comprising a duplicator controlled by the processor that duplicates a data image into one of the plurality of optical disks after the processor enables access to the plurality of optical disks from the media cartridge.

16. The system of claim 12, further comprising:
a reader that interrogates a medium identification tag (MID) that identifies the plurality of optical disks; and
a duplicator controlled by the processor that duplicates a data image into the plurality of optical disks, wherein the processor enables the plurality of optical disks to be duplicated after the MID is recognized as associated with the CID.

17. A system comprising:
a plurality of optical disks each comprising a medium identification tag (MID) that identifies each of the plurality of optical disks;
a media cartridge comprising:
a cartridge housing that houses the plurality of optical disks, wherein the cartridge housing forms an opening that allows removal of the optical disks from the cartridge housing;
a mechanical lockout mechanism attached to the cartridge housing that prevents re-insertion of the optical disks into the cartridge housing; and
a cartridge identification tag (CID) that identifies the cartridge;
a first reader that interrogates the MID;
a second reader that interrogates the CID; and
a processor that enables access to the media cartridge and the plurality of optical disks when the MID and CID are recognized.

18. The system of claim 17, wherein the mechanical lockout mechanism comprises:
a securing arm that slides along a channel formed within the cartridge housing;
a plunger that mates to one or more teeth of the rack, wherein the plunger is attached to the securing arm; and
a bias member that forces the plunger against the one or more teeth of the rack, wherein the one or more teeth of the rack mated to the plunger prevent the securing arm from moving away from the opening of the cartridge housing.

19. The system of claim 17, wherein the mechanical lockout mechanism comprises:
a securing member that slides along a center post within the cartridge housing, wherein the plurality of optical disks surround the center post;
a locking member that mates to an indent formed within the center post, wherein the locking member is attached to the securing member; and
a bias member that forces the locking member against the indent, wherein the locking member mates to the indent when the plurality of optical disks are removed from the cartridge housing.

20. The system of claim 17, wherein the mechanical lockout mechanism comprises a plurality of biased fingers attached to the cartridge housing that pivot via force from the plurality of optical disks to allow removal of one of the optical disks from the cartridge housing, wherein the plurality of biased fingers are equally spaced around a circumference of the cartridge housing.
